(19) United States
(12) Patent Application Publication
(10) Pub. No.: US 2006/0116176 A1
(43) Pub. Date: Jun. 1, 2006

(54) Apparatus for alerting others that a person is talking on a cellular telephone

(76) Inventors: David Shenkman, Miami, FL (US); David F. Potts, Fort Lauderdale, FL (US)

Correspondence Address: FRANK L. KUBLER, 13261 S.W. 54th Court, Miramar, FL, 33027, US

(21) Appl. No.: 11/199,553

(22) Filed: Aug. 8, 2005

Related U.S. Application Data
(60) Provisional application No. 60/600,737, filed on Aug. 11, 2004.

(51) Int. Cl. H04B 1/38

(52) U.S. Cl. 455/567

(57) ABSTRACT

An alert apparatus for connection to a cellular telephone for alerting approaching persons that the user of the cellular telephone is speaking on the telephone and is thus occupied, the apparatus including an apparatus connecting means for connecting to the cellular telephone circuit; an apparatus circuit extending from the apparatus connecting means and including an apparatus power source, active circuit detection means connected to the connecting means for detecting when the telephone microphone is operational and for sending an actuating signal only when the telephone microphone is operational, alerting means connected to the detection means for receiving the actuating signal from the detection means and thereupon generating a bystander alert when the telephone microphone is operational.

### FILING HISTORY

This application continues from provisional application No. 60/600,737 filed on Aug. 11, 2004.

### BACKGROUND OF THE INVENTION

1. Field of the Invention

The present invention relates generally to the field of telecommunications equipment. More specifically the present invention relates to an alert apparatus for connection to a cellular telephone circuit such as to a stereo plug jack to alert with signalling means anyone approaching a person with a cellular telephone that a telephone conversation is in progress, the cellular telephone user is occupied. The signalling means preferably is a flashing light source such as a light emitting diode (LED), and the alert apparatus preferably includes a mute switch. The alert apparatus may interconnect the telephone and a conventional hands-free telephone headset, or may be incorporated into a headset or into the telephone itself. The apparatus preferably includes a line connecting a cellular telephone to a headset and a housing with a display face having an LED port through which the LED is exposed and having a mute switch port through which the mute switch is accessible.

The LED is activated only when the telephone microphone is operational, during call sending and receiving. The apparatus power source preferably is external, taking the form of a three-volt silver oxide cell, so that the power source does not effect cellular telephone operation. The circuit begins at a telephone stereo plug jack and connects to a headset speaker and to an electret headset microphone, the microphone connection being through a normally closed switch functioning as the mute switch, and connects to an LED and second resistor combination mounted in parallel, and to a battery power source through a first resistor as well as to a pair of NPN transistors forming a Darlington pair.

2. Description of the Prior Art

There have in recent years been a variety of cellular telephone and corresponding headset devices. A problem with these prior devices has been that it is not always readily apparent that a person is talking on the headset, and as a result people approach and try to begin conversations with a person who is already thereby occupied.

It is thus an object of the present invention to provide an apparatus which alerts people approaching a person with a cellular telephone that he or she is talking on the telephone so that they do not unknowingly interrupt the occupied person.

It is another object of the present invention to provide such an apparatus which connects to a cellular telephone headset and alerts approaching people with a light, and preferably a flashing light.

It is still another object of the present invention to provide such an apparatus which can be provided in a line interconnecting a cellular telephone stereo plug jack and a conventional or generic headset.

It is finally an object of the present invention to provide such an apparatus which is compact, easy to use, reliable, aesthetically pleasing and relatively inexpensive to manufacture.

### SUMMARY OF THE INVENTION

The present invention accomplishes the above-stated objectives, as well as others, as may be determined by a fair reading and interpretation of the entire specification.

An alert apparatus is provided for connection to a cellular telephone for alerting approaching persons that the user of the cellular telephone is speaking on the telephone and is thus occupied, the apparatus including an apparatus connecting means for connecting to the cellular telephone circuit; an apparatus circuit extending from the apparatus connecting means and including an apparatus power source, active circuit detection means connected to the connecting means for detecting when the telephone microphone is operational and for sending an actuating signal only when the telephone microphone is operational, alerting means connected to the detection means for receiving the actuating signal from the detection means and thereupon generating a bystander alert when the telephone microphone is operational. The connecting means preferably is an apparatus plug fitting into a cellular telephone jack. The alerting means preferably includes a light source and the alert preferably takes the form of a flashing light. The light source preferably is a light emitting diode. The apparatus preferably additionally includes a mute switch connected to a portion of the apparatus circuit leading to or from telephone microphone, the mute switch being normally closed and being opened only by depressing a mute button on the switch and thereby opening the mute switch and preventing current from flowing through the microphone, thereby disabling the microphone and thus preventing sound from being transmitted through the cellular telephone. The alert apparatus preferably interconnects the telephone and a conventional hands-free cellular telephone headset. Alternatively the alert apparatus is incorporated into a telephone headset or into the telephone itself.

The apparatus power source preferably is external, and preferably includes a three-volt silver oxide cell. The apparatus circuit preferably includes a headset speaker and an electret headset microphone, the microphone connection being through a normally closed switch functioning as the mute switch and connecting to the light emitting diode and a second resistor combination mounted in parallel, and to a battery power source through a first resistor as well as to a pair of NPN transistors forming a Darlington pair.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the preferred embodiment of the apparatus incorporated into a headset line leading from a headset to a cellular telephone.

FIG. 2 is a circuit diagram of one preferred apparatus circuit.

FIG. 3 is a circuit diagram of another preferred apparatus circuit.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### FIRST PREFERRED EMBODIMENT

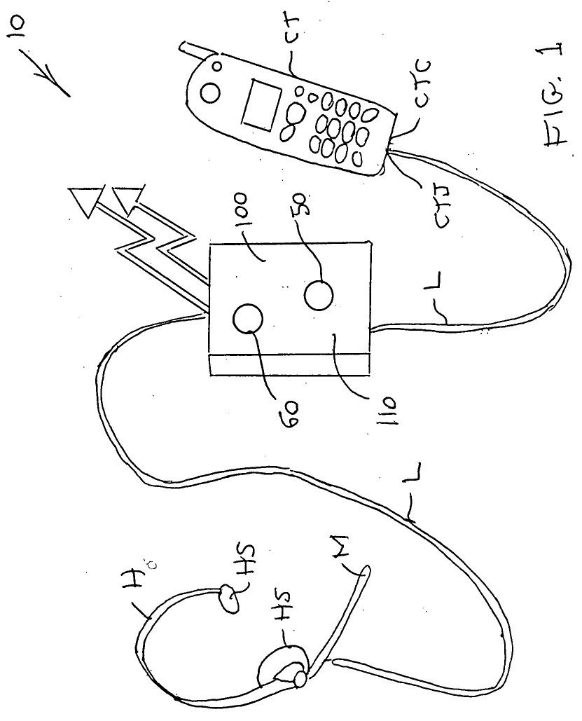

Referring to FIGS. 1-3, an alert apparatus 10 for connection to a cellular telephone circuit CTC is disclosed including apparatus connecting means 20 for connecting the apparatus 10 to a cellular telephone CT, detection means 30 for detecting when the telephone CT is in use and signalling means 40 for alerting bystanders that a telephone conversation is in progress, so that they will know that the cellular telephone user is occupied. The signally means 40 preferably is a flashing light source 50 such as a light emitting diode (LED), and the alert apparatus 10 preferably includes a mute switch 60. The alert apparatus 10 may interconnect the telephone CT and a conventional hands-free telephone headset H, or may be incorporated into a headset H or into the telephone CT itself. Apparatus 10 preferably is mounted in a line L connecting a cellular telephone CT to a headset H and is housed within an apparatus housing 100 in the form of a box with a display face 110 having an LED port through which the LED 50 is exposed and having a mute switch port through which the mute switch 60 is accessible.

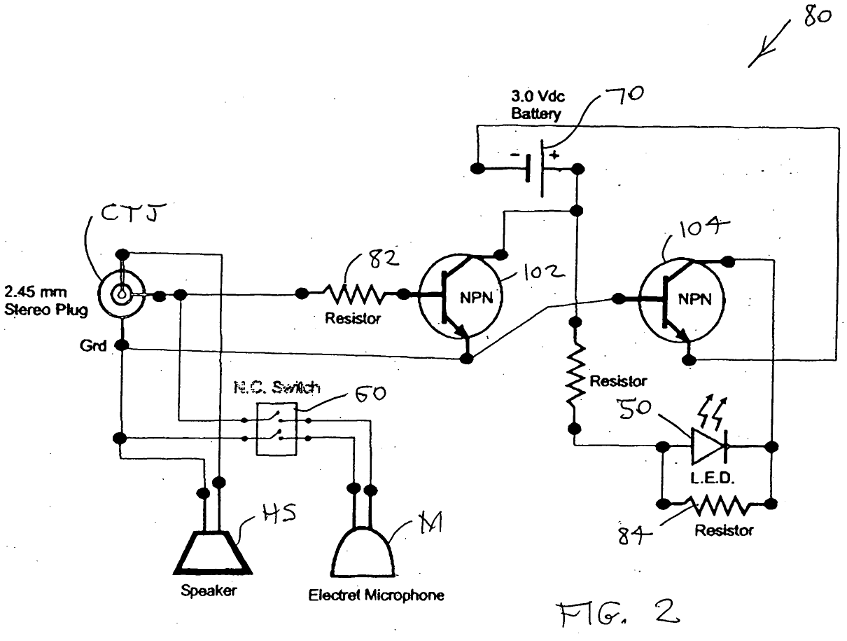

The LED 50 is activated only when the telephone microphone M is operational, during call sending and receiving. The apparatus power source 70 preferably is external, taking the form of a three-volt silver oxide cell, so that the power source 70 does not effect cellular telephone CJ operation. A circuit diagram of apparatus 10 is provided in FIG. 2. The circuit 80 begins at a telephone stereo plug jack CTJ and connects to the headset speaker HS and to an electret microphone M, the microphone M connection being through a normally closed (N.C.) switch functioning as the mute switch 60, and connects to an LED 50 and second resistor 84 combination mounted in parallel, and to a battery power source 70 through a first resistor 82 as well as to a first NPN transistor 102 and second NPN transistor 104 together forming a Darlington pair, amplifying the operational signal from the stereo plug jack CT. The second resistor 84 is shown, by way of example only, as being 5.10 Ohms. The battery power source 70 is shown, again by way of example only, as being 3.0 Volts direct current Vdc.

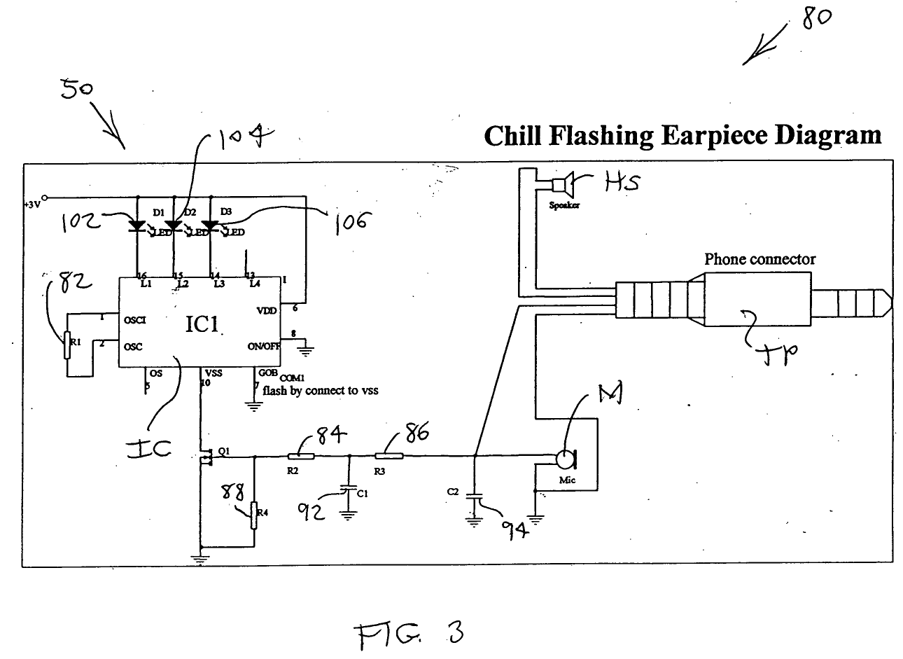

An alternative apparatus circuit 80 is illustrated in FIG. 3. The circuit 80 permits the apparatus 10 to flash light from light emitting diodes in one second intervals. This circuit 80 flashes only when the cellular telephone receives or transmits calls. The flashing function is activated through the signal from the cellular telephone CT to the microphone M. The apparatus 10 also incorporates an earphone E in which a speaker HS has been placed. The function of apparatus 10 is initiated by the cellular telephone CT, but the integrated circuit 80 and light emitting diodes 50 receive their power from two coin style batteries 70. This particular circuit 80 utilizes three diodes 102, 104 and 106, one telephone plug TP, one microphone M, one speaker HS, two capacitors 92 and 94, four resistors 82-88, one integrated circuit IC, two coin batteries 70 and one enhanced MOSFET. This circuit 80 is similar to the above-described version, except that it is designed to work with other types of cellular telephones CT and more for efficiency than the above circuit 80 and thus is believed to be more dependable.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An alert apparatus for connection to a cellular telephone for alerting approaching persons that the user of the cellular telephone is using the telephone, comprising:
an apparatus connecting means for connecting to a cellular telephone circuit;
an apparatus circuit extending from said apparatus connecting means and including an apparatus power source, active circuit detection means connected to the connecting means for detecting when the telephone microphone is operational and for sending an actuating signal only when the telephone microphone is operational, alerting means connected to the detection means for receiving the actuating signal from the detection means and thereupon generating a bystander alert when the telephone microphone is operational.

2. The alert apparatus of claim 1, wherein said connecting means comprises an apparatus plug fitting into a cellular telephone jack.

3. The alert apparatus of claim 1, wherein said alerting means comprises a light source and wherein said alert comprises a flashing light.

4. The alert apparatus of claim 1, wherein said light source comprises a light emitting diode.

5. The alert apparatus of claim 1, additionally comprising a mute switch having a mute switch button connected to a portion of said apparatus circuit leading one of to and from a telephone microphone, said mute switch being normally closed and being opened only by depressing said mute switch button and thereby opening said mute switch and preventing current from flowing through said microphone, thereby disabling said microphone and thus preventing sound from being transmitted through said cellular telephone.

6. The alert apparatus of claim 1, wherein said apparatus power source is external and comprises a three-volt silver oxide cell.

7. The alert apparatus of claim 5, wherein said apparatus circuit comprises a headset speaker and an electret headset microphone, said microphone connection being through a normally closed switch functioning as said mute switch and connecting to said light emitting diode and a second resistor combination mounted in parallel, and to a battery power source through a first resistor as well as to a first NPN transistor and second NPN transistor together forming a Darlington pair.

8. An alert cellular telephone system, comprising:
a cellular telephone having a cellular telephone circuit;
an apparatus for connection to said cellular telephone for, alerting approaching persons that the user of the cellular telephone is using the telephone;
an apparatus connecting means for connecting to a cellular telephone circuit;
and an apparatus circuit extending from said apparatus connecting means and including an apparatus power source, active circuit detection means connected to the connecting means for detecting when the telephone microphone is operational and for sending an actuating signal only when the telephone microphone is operational, alerting means connected to the detection means for receiving the actuating signal from the detection means and thereupon generating a bystander alert when the telephone microphone is operational.

9. The alert apparatus of claim 8, wherein said connecting means comprises an apparatus plug fitting into a cellular telephone jack.

10. The alert apparatus of claim 8, wherein said alerting means comprises a light source.

11. The alert apparatus of claim 8, wherein said alert comprises a flashing light.

12. The alert apparatus of claim 8, wherein said light source comprises a light emitting diode.

13. The alert apparatus of claim 8, additionally comprising a mute switch having a mute switch button connected to a portion of said apparatus circuit leading one of to and from a telephone microphone, said mute switch being normally closed and being opened only by depressing said mute switch button and thereby opening said mute switch and preventing current from flowing through said microphone, thereby disabling said microphone and thus preventing sound from being transmitted through said cellular telephone.

14. The alert apparatus of claim 8, wherein said apparatus power source is external and comprises a three-volt silver oxide cell.
